(19) United States
(12) Patent Application Publication
(10) Pub. No.: US 2009/0127501 A1
(43) Pub. Date: May 21, 2009

(54) Polishing Composition for Silicon Wafer

(75) Inventors: Yoshiyuki Kashima, Sodegaura-shi (JP); Masaaki Ohshima, Sodegaura-shi (JP); Eiichirou Ishimizu, Sodegaura-shi (JP); Naohiko Suemura, Sodegaura-shi (JP)

Correspondence Address: OLIFF & BERRIDGE, PLC, P.O. BOX 320850, ALEXANDRIA, VA, 22320-4850, US

(73) Assignee: Nissan Chemical Industries, Ltd., Tokyo (JP)

(21) Appl. No.: 11/918,253

(22) PCT Filed: May 17, 2006
(86) PCT No.: PCT/JP2006/309828

§ 371 Date: Aug. 6, 2008

(30) Foreign Application Priority Data
May 27, 2005 (JP) 2005-154992

(51) Int. Cl. C09K 13/02; C09K 13/00

(52) U.S. Cl. 252/79.5; 252/79.1

(57) ABSTRACT

The present invention relates to a polishing composition for silicon wafer comprising silica, a basic compound, a polyaminopolycarboxylic acid compound having hydroxy group, and water. The polishing composition can prevent metal contamination by nickel, chromium, iron, copper or the like, particularly copper contamination in polishing of silicon wafer.

### TECHNICAL FIELD

The present invention relates to a polishing composition that makes possible to prevent efficiently metal pollution on silicon wafers.

### BACKGROUND ART

In general, the production process of semiconductor silicon wafer comprises a slicing step of slicing a single crystal ingot to obtain a wafer in the form of thin disc, a chamfering step of chamfering the periphery of the wafer obtained in the slicing step in order to prevent cracks and break of the wafer, a lapping step of planing the chamfered wafer, an etching step of removing process strain remaining in the chamfered and lapped wafer, a polishing step of mirror-polishing the etched wafer surface and a cleaning step of cleaning the polished wafer to remove abrasives or foreign materials adhered thereto.

In the above-mentioned polishing step, generally polishing is carried out by using a polishing composition obtained by dispersing fine abrasive of silica in water and further adding chemical polishing accelerators such as inorganic alkali, ammonium salt, amine, or the like.

However, the alkaline silica-containing polishing composition contains trace amounts of metal impurities. The metal impurities contained in the polishing composition include nickel, chromium, iron, copper or the like. These metal impurities easily adhere to the silicon wafer surface in an alkaline solution. The adherent metal impurity, particularly copper has a high diffusion coefficient, and easily diffuses into the crystal of the silicon wafer. It becomes clear that the metal impurities diffused into the crystal cannot be removed by subsequent cleaning, thereby causing deterioration in qualities of the silicon wafer and lowering in characteristics of semiconductor device manufactured by using the wafer.

As a countermeasure against metal contamination on semiconductor wafer resulting from the silica-containing polishing composition, a method by use of a highly purified polishing composition may be mentioned. An example is disclosed in which a semiconductor wafer is polished by using a silica sol containing each iron, chromium, nickel, aluminum and copper in a content less than 1 mass ppb (see, Patent Document 1). However, the high purified polishing composition is generally expensive and therefore cost for polishing presents a problem.

In addition, even when a composition having a high purity is used, in an actual polishing, metal contamination from a polishing pad, a polishing apparatus or piping system is unavoidable. Therefore, even in case where a composition having a high purity is prepared, it is difficult to prevent metal contamination on semiconductor wafer. This has been acknowledged as a problem.

As mentioned above, a polishing composition that is able to efficiently prevent metal contamination by nickel, chromium, iron, copper or the like has been needed.

Patent Document 1: JP-A-11-214338 (1999) (claims)

### DISCLOSURE OF INVENTION

### Problems to be Solved by the Invention

An object of the present inventors is to provide a polishing composition for silicon wafer that can efficiently prevent metal contamination by nickel, chromium, iron, copper or the like, particularly copper contamination.

### Means for solving the Problems

The present invention relates to a polishing composition for silicon wafer comprising silica; a basic compound; a polyaminopolycarboxylic acid compound having hydroxy group; and water.

The preferable mode of the polishing composition includes the polishing composition, wherein the polyaminopolycarboxylic acid compound is at least one selected from the group consisting of polyaminopolycarboxylic acid compounds of formulae (1), (2) and (3), and the salts thereof:

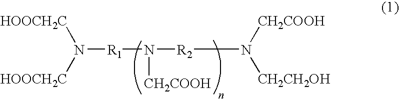

wherein R₁ and R₂ are identical or different each other, C₁₋₁₂alkylene group, and n is an integer of 0 to 4,

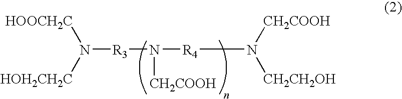

wherein R₃ and R₄ are identical or different each other, C₁₋₁₂alkylene group, and n is an integer of 0 to 4, and

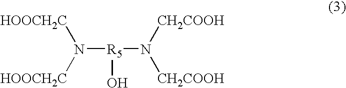

wherein R₅ is C₁₋₁₂alkylene group having hydroxy group.

The preferable modes of the polishing composition include also the following polishing compositions:

wherein the silica is a silica sol;

wherein the silica has an average particle diameter of 5 to 500 nm, and a concentration of 0.05 to 30 mass % based on the total mass of the polishing composition;

wherein the basic compound has a concentration of 0.01 to 10 mass % based on the total mass of the polishing composition;

wherein the basic compound is at least one selected from the group consisting of inorganic salts of alkali metal, ammonium salts and amines;

wherein the inorganic salt of alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate and potassium hydrogen carbonate;

wherein the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride and tetraethylammonium chloride;

wherein the amine is at least one selected from the group consisting of ethylenediamine, monoethanol amine, 2-(2-aminoethyl)aminoethanol amine and piperazine;

wherein the polyaminopolycarboxylic acid compound is at least one selected from the group consisting of N-(2-hydroxyethyl)ethylenediamine triacetic acid, N-(2-hydroxyethyl)diethylenetriamine tetraacetic acid, N-(2-hydroxyethyl)triethylenetetramine pentaacetic acid, as represented as formula (1), and the salts thereof;

wherein the polyaminopolycarboxylic acid compound is at least one selected from the group consisting of N,N′-bis(2-hydroxyethyl)ethylenediamine diacetic acid, N,N″-bis(2-hydroxyethyl)diethylenetriamine triacetic acid, and N,N′″-bis(2-hydroxyethyl)triethylenetetramine tetraacetic acid, as represented as formula (2), and the salts thereof;

wherein the polyaminopolycarboxylic acid compound is at least one selected from the group consisting of hydroxyethylenediamine tetraacetic acid, 1-hydroxy-1,3-diaminopropane tetraacetic acid, 2-hydroxy-1,3-diaminopropane tetraacetic acid, as represented as formula (3), and the salts thereof; and

wherein the salt of the polyaminopolycarboxylic acid compound is an alkaline salt, an ammonium salt or an amine salt.

### EFFECT OF THE INVENTION

According to the present invention, it was found that the addition of at least one compound selected from the polyaminopolycarboxylic acid compound having hydroxy group and the salts thereof to a silica-containing polishing composition exerts an effect of inhibiting metal contamination, particularly copper contamination into silicon wafers and on the surface thereof while maintaining a high removal rate. In particular, as the polishing composition exerts an effect also for amines, copper contamination can be inhibited while maintaining a high removal rate. Further, as it is not required to increase the purity of the polishing composition, metal contamination can be inhibited in a low cost.

### BEST MODE FOR CARRYING OUT THE INVENTION

The embodiments of the present invention will be described. In the present invention, silica (silicon dioxide) is used as an abrasive. Although it is known that ceria and alumina as abrasives for grinding or polishing silicon wafers are effective, silica is suitable as an abrasive for the polishing composition of the present invention. In addition, as silica, silica sol, fumed silica, precipitated silica or silica in other form is known, and any silica among them can be used in the present invention. In particular, in order to polish semiconductor surface in a high precision, it is preferable to use a silica sol (a stable dispersion of silica particles) containing particles having homogeneous particle diameter and an average particle diameter of colloidal dimension (nano dimension).

The silica sol used in the present invention may be any silica sol obtained according to any known production methods. The production method is not specifically limited. As the production method of silica sol, JP-B-46-20137 (1971) discloses a production method of concentrated aqueous silica sol comprising adding an aqueous colloidal solution of active silicic acid in an alkali silicate aqueous solution while evaporating off water at a temperature of 90° C. or more. JP-A-60-251119 (1985) discloses a production method of silica sol having large particle diameter comprising adding an aqueous colloidal solution of active silicic acid in an alkali silicate aqueous solution to prepare a silica sol in which silica particles of 40 to 120 nm are dispersed in a disperse medium, then maturing it after adding an acid, and further concentrating through a fine porous membrane. JP-B49-4636 (1974) discloses a production method of stable silica sol having arbitrary and desired particle diameter comprising heating an aqueous silica sol under a specific condition. In addition, JP-B-41-3369 (1966) discloses a production method of highly purified silica sol comprising subjecting an alkali silicate aqueous solution to de-alkalization process with acid type cation exchange resin to obtain a silicate sol, adding nitric acid in the sol to adjust pH 1.2, maturing at ordinary temperature for 72 hours, then passing through an acid type strong acid cation exchange resin and an hydroxy type anion exchange resin, immediately adding sodium hydroxide therein to adjust pH 8.0, and concentrating with evaporation under vacuum at 80° C. while maintaining a constant level of solution in a vessel. JP-A-63-285112 (1988) discloses a production method of silica sol having high purity and large particle diameter comprising subjecting an alkali silicate aqueous solution to de-alkalization process with acid type cation exchange resin to obtain a silicate sol, adding a strong acid in the sol to adjust pH 0 to 2, aging, then passing through an acid type strong acid cation exchange resin and an hydroxy type anion exchange resin, adding a highly purified alkali metal hydroxide aqueous solution therein to obtain a stabilized silica aqueous colloid having a high purity adjusted to pH 7 to 8, adding the stabilized silica aqueous colloid having a high purity to a heating stabilized silica aqueous colloid having a high purity at a temperature of 90 to 120° C. to a silica sol, maturing the silica sol after adding an acid therein, and further concentrating through a fine porous membrane. Further, JP-A-63-74911 (1988) discloses a production method of finely spherical silica comprising hydrolyzing an alkoxy silane in a water-alcohol mixed solution containing an alkaline catalyst. In the meanwhile, the average particle diameter of silica is an average particle diameter (D nm) calculated from a specific surface area (S m²/g) measured by nitrogen adsorption method (BET method) according to the formula of D=2720/S. The average particle diameter is generally 3 to 1000 nm, preferably 5 to 500 nm, most preferably 10 to 500 nm, which falls into colloidal dimension. Further, the mass proportion of the silica added is generally 0.05 to 30 mass %, preferably 0.1 to 10 mass %, more preferably 1 to 5 mass % based on the total mass of the polishing composition. In case where the proportion is 0.05 mass % or less, sufficient removal rate is not obtained. On the other hand, in case where it is 30 mass % or more, it cannot be expected to improve removal rate.

The basic compounds used in the present invention are inorganic salts of alkali metal, ammonium salts or amines. The salts of alkali metal include hydroxides or carbonate of alkali metals and the like. Specifically, lithium hydroxide, sodium hydroxide, potassium hydroxide, lithium carbonate, sodium carbonate, potassium carbonate, lithium hydrogen carbonate, sodium hydrogen carbonate, potassium hydrogen carbonate and the like are preferable. Particularly, sodium hydroxide, potassium hydroxide, sodium carbonate, potassium carbonate and the like are more preferable.

The ammonium salt is preferably ammonium hydroxide, ammonium carbonate, ammonium hydrogen carbonate, quaternary ammonium salts and the like, particularly ammonium hydroxide and quaternary ammonium salts are more preferable. Specific examples of the quaternary ammonium salts are tetramethylammonium hydroxide, tetraethylammonium hydroxide, tetramethylammonium chloride, tetraethylammonium chloride and the like, particularly tetramethylammonium hydroxide is more preferable. The amines include ethylenediamine, monoethanol amine, 2-(2-aminoethyl)aminoethanol amine, piperazine and the like. The amines are not limited to these amines, and may contain other amines.

Although the preferable added amount of the basic compound is not absolutely determined as it varies depending on what material is used, it is generally 0.01 to 10 mass % based on the total mass of the polishing composition. In particular, in case where the polishing accelerator is an alkali metal salt, it is preferably 0.01 to 1.0 mass %, in case where an ammonium salt is used, it is preferably 0.01 to 5 mass %, and in case where an amine is used, it is preferably 0.1 to 10 mass %. When the amount is less than 0.01 mass %, the effect of the polishing accelerator is not fully exerted. On the other hand, even when added in an amount of 10 mass % or more, it cannot be expected to further improve removal rate. In addition, the above-mentioned basic compounds can be used in a mixture of two or more.

The compounds of formulae (1), (2) and (3) are chelating agents of polyaminopolycarboxylic acid having hydroxy group. The polyaminopolycarboxylic acid compounds used in the present invention are commercially available as chelating agents, and can be easily obtained.

The polyaminopolycarboxylic acid compound includes N-(2-hydroxyethyl)ethylenediamine triacetic acid, N-(2-hydroxyethyl)diethylenetriamine tetraacetic acid, and N-(2-hydroxyethyl)triethylenetetramine pentaacetic acid, as represented as formula (1), and the salts thereof. These compounds can be used in a mixture of two or more.

The polyaminopolycarboxylic acid compound includes N,N′-bis(2-hydroxyethyl)ethylenediamine diacetic acid, N,N″-bis(2-hydroxyethyl)diethylenetriamine triacetic acid, and N,N′″-bis(2-hydroxyethyl)triethylenetetramine tetraacetic acid, as represented as formula (2), and the salts thereof. These compounds can be used in a mixture of two or more. The polyaminopolycarboxylic acid compound includes hydroxyethylenediamine tetraacetic acid, 1-hydroxy-1,3-diaminopropane tetraacetic acid, 2-hydroxy-1,3-diaminopropane tetraacetic acid, as represented as formula (3), and the salts thereof. These compounds can be used in a mixture of two or more.

Although the added amount of the polyaminopolycarboxylic acid compound of formulae (1), (2) and (3), and the salt thereof varies depending on the kind of the compound used and is not specifically limited so long as the effect of the present invention is exerted, it is 0.001 to 10 mass %, preferably 0.01 to 10 mass %, more preferably 0.1 to 5 mass % based on the total mass of the polishing composition. In case where the amount is less than 0.001 mass %, the effect by the addition is not fully exerted and therefore the effect of preventing metal contamination is not fully exerted in many cases. On the other hand, even when added in an amount over 10 mass %, it cannot be expected to exert further effect by the addition.

### EXAMPLES

Hereinafter, the examples of the present invention will be described. In the meanwhile, the present invention is not limited to the examples

### Example 1

A silica sol [silica concentration: 3.0 mass %, average particle diameter: 45 nm, copper concentration (hereinafter referred to as Cu concentration): 5 mass ppb, adjusted to pH 9 with sodium hydroxide (hereinafter referred to as NaOH)] was prepared as a base material of polishing composition (hereinafter referred to as polishing solution), and was compulsorily contaminated with copper by adding a standard copper solution for atomic absorption spectrometry analysis (copper nitrate solution having Cu concentration of 1000 mass ppm) in the silica sol so as to have Cu concentration of 10 mass ppb.

In the silica sol contaminated with copper as mentioned above, NaOH and N-(2-hydroxyethyl)ethylenediamine triacetic acid (hereinafter referred to as HEDTA) were added so as to have a concentration of 0.1 mass % and 0.1 mass %, respectively to prepare a polishing solution.

P type (100) semiconductor silicon wafer was polished for 30 minutes by using the polishing solution. For polishing, a commercially available one-side polishing machine was used.

The wafer was subjected to a known SC1 cleaning (treatment of dipping in a cleaning solution (SC1 solution) of ammonia:hydrogen peroxide:water mixed in a ratio of 1:1 to 2:5 to 7 at 75 to 85° C. for 10 to 20 minutes) and SC2 cleaning (treatment of dipping in a cleaning solution (SC2 solution) of hydrochloric acid:hydrogen peroxide:water mixed in a ratio of 1:1 to 2:5 to 7 at 75 to 85° C. for 10 to 20 minutes) to remove impurities on the wafer surface, then the cleaned wafer was subjected to heat treatment at 650° C. for 20 minutes, copper on the wafer surface was recovered by adding dropwise HF/H₂O₂, and metal impurities in the recovered solution was subjected to quantitative analysis with Inductively Coupled Plasma Mass Spectrometry (hereinafter referred to as ICP-MS).

### Example 2

A polishing solution was prepared by adding in the silica sol contaminated with copper similar to that in Example 1, NaOH and HEDTA so as to have a concentration of 0.1 mass % and 0.05 mass %, respectively. Polishing was carried out for 30 minutes by using the polishing solution, and quantitative analysis of copper was carried out.

### Example 3

A polishing solution was prepared by adding in the silica sol contaminated with copper similar to that in Example 1, NaOH and HEDTA so as to have a concentration of 0.1 mass % and 0.5 mass %, respectively. Polishing was carried out for 30 minutes by using the polishing solution, and quantitative analysis of copper was carried out.

### Example 4

A polishing solution was prepared by adding in the silica sol contaminated with copper similar to that in Example 1, piperazine and HEDTA so as to have a concentration of 0.1 mass % and 0.1 mass %, respectively. Polishing was carried out for 30 minutes by using the polishing solution, and quantitative analysis of copper was carried out.

### Example 5

A polishing solution was prepared by adding in the silica sol contaminated with copper similar to that in Example 1, piperazine and HEDTA so as to have a concentration of 0.5 mass % and 0.1 mass %, respectively. Polishing was carried out for 30 minutes by using the polishing solution, and quantitative analysis of copper was carried out.

### Example 6

A polishing solution was prepared by adding in the silica sol contaminated with copper similar to that in Example 1, piperazine and HEDTA so as to have a concentration of 1.5 mass % and 0.1 mass %, respectively. Polishing was carried out for 30 minutes by using the polishing solution, and quantitative analysis of copper was carried out.

### Example 7

A polishing solution was prepared by adding in the silica sol contaminated with copper similar to that in Example 1, tetramethylammonium hydroxide (hereinafter referred to as TMAH) and HEDTA so as to have a concentration of 0.1 mass % and 0.1 mass %, respectively. Polishing was carried out for 30 minutes by using the polishing solution, and quantitative analysis of copper was carried out.

### Example 8

A polishing solution was prepared by adding in the silica sol contaminated with copper similar to that in Example 1, NaOH and N,N′-bis(2-hydroxyethyl)ethylenediamine diacetic acid (hereinafter referred to as HEDDA) so as to have a concentration of 0.1 mass % and 0.1 mass %, respectively. Polishing was carried out for 30 minutes by using the polishing solution, and quantitative analysis of copper was carried out.

### Example 9

A polishing solution was prepared by adding in the silica sol contaminated with copper similar to that in Example 1, piperazine and HEDDA so as to have a concentration of 0.5 mass % and 0.1 mass %, respectively. Polishing was carried out for 30 minutes by using the polishing solution, and quantitative analysis of copper was carried out.

### Example 10

A polishing solution was prepared by adding in the silica sol contaminated with copper similar to that in Example 1, TMAH and HEDDA so as to have a concentration of 0.1 mass % and 0.1 mass %, respectively. Polishing was carried out for 30 minutes by using the polishing solution, and quantitative analysis of copper was carried out.

### Example 11

A polishing solution was prepared by adding in the silica sol contaminated with copper similar to that in Example 1, NaOH and 2-hydroxy-1,3-diaminopropane tetraacetic acid (hereinafter referred to as DPTA-OH) so as to have a concentration of 0.1 mass % and 0.1 mass %, respectively. Polishing was carried out for 30 minutes by using the polishing solution, and quantitative analysis of copper was carried out.

### Example 12

A polishing solution was prepared by adding in the silica sol contaminated with copper similar to that in Example 1, piperazine and DPTA-OH so as to have a concentration of 0.5 mass % and 0.1 mass %, respectively. Polishing was carried out for 30 minutes by using the polishing solution, and quantitative analysis of copper was carried out.

### Example 13

A polishing solution was prepared by adding in the silica sol contaminated with copper similar to that in Example 1, TMAH and DPTA-OH so as to have a concentration of 0.1 mass % and 0.1 mass %, respectively. Polishing was carried out for 30 minutes by using the polishing solution, and quantitative analysis of copper was carried out.

### Example 14

A polishing solution was prepared by adding in the silica sol as a base material similar to that in Example 1 that was not contaminated with copper, NaOH and DPTA-OH so as to have a concentration of 0.1 mass % and 0.1 mass %, respectively. Polishing was carried out for 30 minutes by using the polishing solution, and quantitative analysis of copper was carried out.

### Example 15

In a silica sol [silica concentration: 3.0 mass %, average particle diameter: 45 nm, Cu concentration: 0.5 mass ppb, adjusted to pH 9 with NaOH] as a base material of polishing composition (polishing solution), NaOH and DPTA-OH were added so as to have a concentration of 0.1 mass % and 0.1 mass %, respectively. Polishing was carried out for 30 minutes by using the polishing solution, and quantitative analysis of copper was carried out.

### Comparative Example 1

A polishing solution was prepared by adding in the silica sol as a base material similar to that in Example 1 that was not contaminated with copper, NaOH so as to have a concentration of 0.1 mass %. Polishing was carried out for 30 minutes by using the polishing solution, and quantitative analysis of copper was carried out.

### Comparative Example 2

A polishing solution was prepared by adding in the silica sol as a base material similar to that in Example 1 that was not contaminated with copper, piperazine so as to have a concentration of 0.5 mass %. Polishing was carried out for 30 minutes by using the polishing solution, and quantitative analysis of copper was carried out.

### Comparative Example 3

A polishing solution was prepared by adding in the silica sol as a base material similar to that in Example 1 that was not contaminated with copper, TMAH so as to have a concentration of 0.1 mass %. Polishing was carried out for 30 minutes by using the polishing solution, and quantitative analysis of copper was carried out.

### Comparative Example 4

A polishing solution was prepared by adding in the silica sol contaminated with copper similar to that in Example 1, NaOH so as to have a concentration of 0.1 mass %. Polishing was carried out for 30 minutes by using the polishing solution, and quantitative analysis of copper was carried out.

### Comparative Example 5

A polishing solution was prepared by adding in the silica sol contaminated with copper similar to that in Example 1, piperazine so as to have a concentration of 0.5 mass %. Polishing was carried out for 30 minutes by using the polishing solution, and quantitative analysis of copper was carried out.

### Comparative Example 6

A polishing solution was prepared by adding in the silica sol contaminated with copper similar to that in Example 1, TMAH so as to have a concentration of 0.1 mass %. Polishing was carried out for 30 minutes by using the polishing solution, and quantitative analysis of copper was carried out.

### Comparative Example 7

A polishing solution was prepared by adding in the silica sol as a base material similar to that in Example 18, NaOH so as to have a concentration of 0.1 mass %. Polishing was carried out for 30 minutes by using the polishing solution, and quantitative analysis of copper was carried out.

TABLE 1

| | | | | Polyaminopolycarboxylic | | | | |
|---|---|---|---|---|---|---|---|---|
| | | Basic material | | acid compound | | | Cu | |
| | Silica | | Added | | Added | Cu compulsory | concentration | Removal |
| | concentration | | amount | | amount | contamination | after polishing | rate |
| | (mass %) | Kind | (mass %) | Kind | (mass %) | (mass ppb) | (atoms/cm²) | (μm/min) |
| Example 1 | 3.0 | NaOH | 0.1 | HEDTA | 0.1 | 10 | 3.7 × 10⁹ | 0.30 |
| Example 2 | 3.0 | NaOH | 0.1 | HEDTA | 0.05 | 10 | 4.2 × 10⁹ | 0.32 |
| Example 3 | 3.0 | NaOH | 0.1 | HEDTA | 0.5 | 10 | 3.1 × 10⁹ | 0.30 |
| Example 4 | 3.0 | Piperazine | 0.1 | HEDTA | 0.1 | 10 | 6.3 × 10⁹ | 0.41 |
| Example 5 | 3.0 | Piperazine | 0.5 | HEDTA | 0.1 | 10 | 6.5 × 10⁹ | 0.52 |
| Example 6 | 3.0 | Piperazine | 1.5 | HEDTA | 0.1 | 10 | 6.8 × 10⁹ | 0.55 |
| Example 7 | 3.0 | TMAH | 0.1 | HEDTA | 0.1 | 10 | 3.3 × 10⁹ | 0.38 |
| Example 8 | 3.0 | NaOH | 0.1 | HEDDA | 0.1 | 10 | 4.2 × 10⁹ | 0.31 |
| Example 9 | 3.0 | Piperazine | 0.5 | HEDDA | 0.1 | 10 | 7.0 × 10⁹ | 0.54 |
| Example 10 | 3.0 | TMAH | 0.1 | HEDDA | 0.1 | 10 | 3.6 × 10⁹ | 0.35 |
| Example 11 | 3.0 | NaOH | 0.1 | DPTA-OH | 0.1 | 10 | 3.5 × 10⁹ | 0.32 |
| Example 12 | 3.0 | Piperazine | 0.5 | DPTA-OH | 0.1 | 10 | 5.8 × 10⁹ | 0.53 |
| Example 13 | 3.0 | TMAH | 0.1 | DPTA-OH | 0.1 | 10 | 3.2 × 10⁹ | 0.36 |
| Example 14 | 3.0 | NaOH | 0.1 | DPTA-OH | 0.1 | None | 3.1 × 10⁹ | 0.29 |
| Example 15 | 3.0 | NaOH | 0.1 | DPTA-OH | 0.1 | None | 2.7 × 10⁹ | 0.31 |

TABLE 2

| | | Basic material | | Polyaminopolycarboxylic | | | Cu | |
|---|---|---|---|---|---|---|---|---|
| | Silica | | Added | acid compound | | Cu compulsory | Concentration | Removal |
| | concentration | | amount | | Added amount | contamination | after polishing | rate |
| | (mass %) | Kind | (mass %) | Kind | (mass %) | (mass ppb) | (atoms/cm²) | (μm/min) |
| Comparative | 3.0 | NaOH | 0.1 | None | 0 | None | 3.8 × 10¹⁰ | 0.29 |
| Example 1 | | | | | | | | |
| Comparative | 3.0 | Piperazine | 0.5 | None | 0 | None | 4.5 × 10¹⁰ | 0.54 |
| Example 2 | | | | | | | | |
| Comparative | 3.0 | TMAH | 0.1 | None | 0 | None | 3.7 × 10¹⁰ | 0.35 |
| Example 3 | | | | | | | | |
| Comparative | 3.0 | NaOH | 0.1 | None | 0 | 10 | 2.5 × 10¹¹ | 0.30 |
| Example 4 | | | | | | | | |
| Comparative | 3.0 | Piperazine | 0.5 | None | 0 | 10 | 3.2 × 10¹¹ | 0.57 |
| Example 5 | | | | | | | | |
| Comparative | 3.0 | TMAH | 0.1 | None | 0 | 10 | 9.8 × 10¹⁰ | 0.35 |
| Example 6 | | | | | | | | |
| Comparative | 3.0 | NaOH | 0.1 | None | 0 | None | 9.0 × 10⁹ | 0.30 |
| Example 7 | | | | | | | | |

The measurement results of copper contamination and the removal rate on polishing wafers are shown in Tables 1 and 2. In case where no polyaminopolycarboxylic acid compound was added as shown in Comparative Examples 1 to 3, contamination of the level of 10¹⁰ atom/cm² was found even when no compulsory contamination was carried out, and copper contamination was further increased when compulsory contamination was carried out as shown in Comparative Example 4 to 6. As shown in Comparative Example 7, even when a silica sol containing copper in a small amount was used, copper contamination in silicon wafer was not able to be fully inhibited. Therefore, when the polyaminopolycarboxylic acid compound having hydroxy group was not added, copper contamination was unavoidable.

Copper contamination of silicon wafer after polishing was able to be inhibited in case where DPTA-OH was added as shown in Example 14 compared with cases where no polyaminopolycarboxylic acid compound was added. In addition, inhibition against copper contamination in silicon wafer was able to be further improved by using a silica sol containing copper in a small amount as shown in Example 15.

Even when compulsory copper contamination was carried out as shown in Examples 11 to 13, copper contamination of silicon wafer after polishing was able to be inhibited to the level of 10⁹ atom/cm² regardless of the kind of basic compounds compared with cases where no polyaminopolycarboxylic acid compound was added. In addition, in also cases where the kind of polyaminopolycarboxylic acid compounds was changed from DPTA-OH to HEDTA or HEDDA, a similar effect inhibiting copper contamination was found as shown in Examples 1 to 10.

Even when polyaminopolycarboxylic acid compounds were added as shown in Examples 1, 5 or 7 to 13, removal rate comparable to Comparative Example 4 to 6 was obtained. That is, any influence on removal rate by the addition of polyaminopolycarboxylic acid compound was not found. In addition, even when basic compounds were added as shown in Examples 4 to 6, any difference in the level of copper contamination was not found, and it was found to fully have an effect of inhibiting copper contamination.

As mentioned above, according to the present invention, it was found to be able to inhibit metal contamination, particularly copper contamination while maintaining a suitable removal rate by adding the polyaminopolycarboxylic acid compound having hydroxy group to silica-containing polishing compositions. In particular, as the polishing composition exerts an effect also for amines, copper contamination can be inhibited while maintaining a high removal rate. Further, as the polishing composition of the present invention is not required to purify a polishing composition to a high purity, it can inhibit metal contamination in a low cost.

1. A polishing composition for silicon wafer comprising silica, a basic compound, a polyaminopolycarboxylic acid compound having hydroxy group, and water.

2. The polishing composition for silicon wafer according to claim 1, wherein the polyaminopolycarboxylic acid compound is at least one selected from the group consisting of polyaminopolycarboxylic acid compounds of formulae (1), (2) and (3), and the salts thereof: 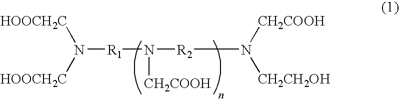
wherein R₁ and R₂ are identical or different each other, C₁₋₁₂alkylene group, and n is an integer of 0 to 4, 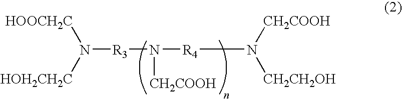
wherein R₃ and R₄ are identical or different each other, C₁₋₁₂alkylene group, and n is an integer of 0 to 4, and 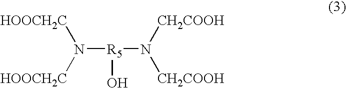
wherein R₅ is C₁₋₁₂alkylene group having hydroxy group.

3. The polishing composition for silicon wafer according to claim 1, wherein the silica is a silica sol.

4. The polishing composition for silicon wafer according to claim 1, wherein the silica has an average particle diameter of 5 to 500 nm, and a concentration of 0.05 to 30 mass % based on the total mass of the polishing composition.

5. The polishing composition for silicon wafer according to claim 1, wherein the basic compound has a concentration of 0.01 to 10 mass % based on the total mass of the polishing composition.

6. The polishing composition for silicon wafer according to claim 1, wherein the basic compound is at least one selected from the group consisting of inorganic salts of alkali metal, ammonium salts and amines.

7. The polishing composition for silicon wafer according to claim 6, wherein the inorganic salt of alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate and potassium hydrogen carbonate.

8. The polishing composition for silicon wafer according to claim 6, wherein the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride and tetraethylammonium chloride.

9. The polishing composition for silicon wafer according to claim 6, wherein the amine is at least one selected from the group consisting of ethylenediamine, monoethanol amine, 2-(2-aminoethyl)aminoethanol amine and piperazine.

10. The polishing composition for silicon wafer according to claim 1, wherein the polyaminopolycarboxylic acid compound is at least one selected from the group consisting of N-(2-hydroxyethyl)ethylenediamine triacetic acid, N-(2-hydroxyethyl)diethylenetriamine tetraacetic acid, N-(2-hydroxyethyl)triethylenetetramine pentaacetic acid, as represented as formula (1), and the salts thereof.

11. The polishing composition for silicon wafer according to claim 1, wherein the polyaminopolycarboxylic acid compound is at least one selected from the group consisting of N,N′-bis(2-hydroxyethyl)ethylenediamine diacetic acid, N,N″-bis(2-hydroxyethyl)diethylenetriamine triacetic acid, and N,N′″-bis(2-hydroxyethyl)triethylenetetramine tetraacetic acid, as represented as formula (2), and the salts thereof;

12. The polishing composition for silicon wafer according to claim 1, wherein the polyaminopolycarboxylic acid compound is at least one selected from the group consisting of hydroxyethylenediamine tetraacetic acid, 1-hydroxy-1,3-diaminopropane tetraacetic acid, 2-hydroxy-1,3-diaminopropane tetraacetic acid, as represented as formula (3), and the salts thereof.

13. The polishing composition for silicon wafer according to claim 1, wherein the salt of the polyaminopolycarboxylic acid compound is an alkaline salt, an ammonium salt or an amine salt.
